(19) United States
(12) Patent Application Publication
(10) Pub. No.: US 2013/0205018 A1
(43) Pub. Date: Aug. 8, 2013

(54) EXTENDING SERVICE DISCOVERY INTO CLOUD COMPUTING

(71) Applicant: Samsung Electronics Co., Ltd., Suwon (KR)

(72) Inventors: Mahfuzur Rahman, San Jose, CA (US); Alan Messer, Los Gatos, CA (US)

(73) Assignee: SAMSUNG ELECTRONICS CO., LTD., Suwon (KR)

(21) Appl. No.: 13/753,416

(22) Filed: Jan. 29, 2013

Related U.S. Application Data
(60) Provisional application No. 61/595,634, filed on Feb. 6, 2012.

(51) Int. Cl. H04L 12/24

(52) U.S. Cl. CPC H04L 41/12
USPC 709/224

(57) ABSTRACT

Providing service discovery in a communication network comprises adding service discovery information for a first network to a domain name system (DNS). The service discovery information provides for devices to discover devices and services that the devices support. Service information is discovered from the service discovery information over the communication network. One or more services from the first network are selected from the discovered service information. One or more services are accessed over the communication network from the first local network.

### CROSS-REFERENCE TO RELATED APPLICATION

This application claims the priority benefit of U.S. Provisional Patent Application Ser. No. 61/595,634, filed on Feb. 6, 2012, incorporated herein by reference.

### TECHNICAL FIELD

An embodiment of the present invention generally relates to connection between local networks, and in particular, extending Universal Plug and Play (UPnP) discovery outside of a local area network (LAN) using domain name system (DNS).

### BACKGROUND

UPnP remote access technologies allow two homes to connect together and allow devices in one home to access devices in the other home with the requirement of establishing a remote access connection between the two homes by connecting two remote access servers. The UPnP service discovery mechanism works in this case as the remote access server in each home proxies discovery messages to the other home. This mechanism, however, is not extensible outside of a LAN.

### SUMMARY

An embodiment of the present invention generally relates to providing service discovery in a communication network. One embodiment of the invention comprises adding service discovery information for a first network to a domain name system (DNS). The service discovery information provides for devices to discover services that other devices support. Service information is discovered from the service discovery information over the communication network. One or more services from the first network are selected from the discovered service information. One or more services are accessed over the communication network from the first network.

Another embodiment includes a computer program product for service discovery in a communication network. The computer program product comprising: a tangible storage medium readable by a computer system and storing instructions for execution by the computer system for performing a method comprising: adding service discovery information for a first network to a DNS. The service discovery information provides for devices to discover services that other devices support. Service information is discovered from the service discovery information over the communication network. One or more services from the first network are selected from the discovered service information. One or more services are accessed over the communication network from the first network.

One embodiment comprises a system including a server coupled to a wide area network (WAN) network. A first local network is coupled to the WAN. A DNS is coupled to the server. The DNS including service discovery information for the first local network. Service information from the local network is discoverable over the WAN using the service discovery information from the DNS.

One embodiment comprises a system including a server coupled to a WAN. A first local network is coupled to the WAN. A domain name system (DNS) is coupled to the WAN. The DNS obtains service discovery information using a publicly accessible Internet protocol (IP) address and port for a link to the service discovery information. Service information from the local network is discoverable over the WAN.

These and other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a diagram of a multi-tier discovery architecture for providing service discovery in a wide area network (WAN), according to an embodiment of the invention.

FIG. 2 shows an architecture for service discovery and multi-home service/content access, according to an embodiment of the invention.

FIG. 3 shows an architecture for multiple home/group member networks connected through a cloud network environment, according to an embodiment of the invention.

FIG. 4 shows an architecture for a family/group cloud network environment that serves as a virtual content directory service that aggregates metadata from multiple content directory sources, according to an embodiment of the invention.

FIG. 5 shows an architecture for the family/group cloud network environment that serves as the authentication and connection establishment server to setup remote access connection between a home/group member network, according to an embodiment of the invention.

FIG. 6 shows an architecture for publication of UPnP Service/device description in a DNS system using of simple traversal of user datagram protocol (UDP) (STUN) through network address translation (NAT) (TURN) traversal using relay NAT, according to an embodiment of the invention.

FIG. 7 shows an architecture for a multi-home service/content access using service discovery in a cloud network environment, according to an embodiment of the invention.

FIG. 8 shows a flowchart for service discovery in a WAN processing, according to an embodiment of the invention.

FIG. 9 shows a block diagram of an example system that may be implemented, according to an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

An embodiment of the present invention generally relates to providing service discovery in a wide area network (WAN), and in particular to extending Universal Plug and Play (UPnP) discovery outside of a local area network (LAN) using a domain name system (DNS). One embodiment of the invention comprises adding service discovery information from a first local network to a DNS. In one embodiment service information is discovered from the service discovery information over the WAN. In one embodiment one or more services are selected from the discovered service information. In one embodiment one or more services are accessed over the WAN from the first local network.

One embodiment of the invention allows extending UPnP service discovery messages to be accessible outside of a local area network, such as in the WAN, without establishing a remote access connection. This embodiment enhances multi-home access by making service discovery messages available in the WAN.

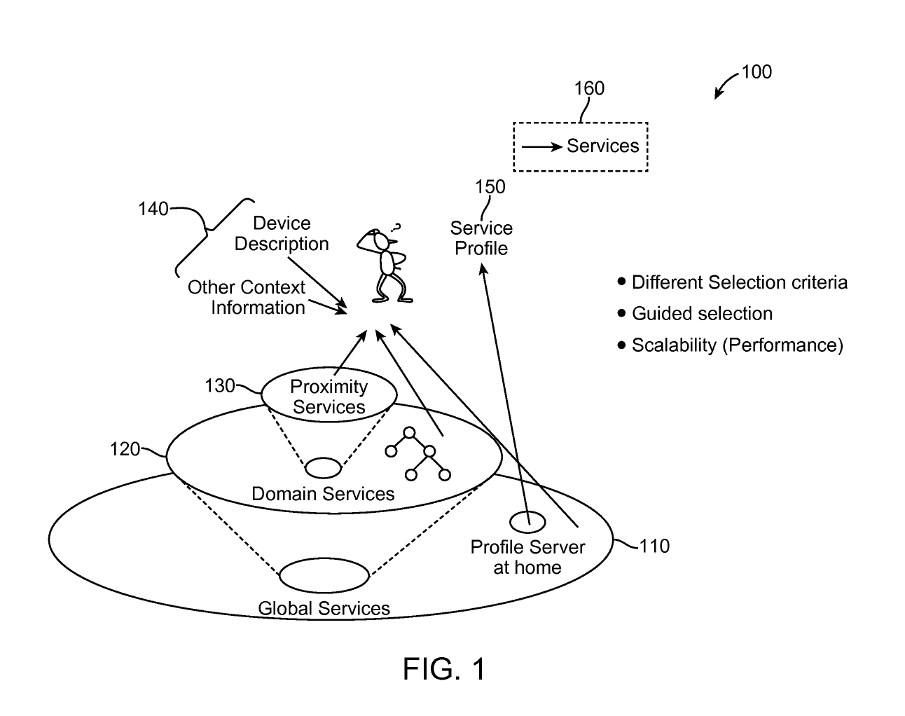

FIG. 1 shows a diagram of a multi-tier discovery architecture 100 for providing service discovery in a WAN (e.g., a cloud network environment), according to an embodiment of the invention. In one embodiment, the multi-tier discovery architecture 100 includes global services 110, domain services 120 and proximity services 130. Example of classifying services may include dividing into proximity, domain and global services.

In one embodiment, service classes (i.e., global services 110, domain services 120 and proximity services 130) are separated by coverage and require device description and context information 140, a service profile 150 that may be provided from profile server 110. The services 160 desired to be provided are accessed through the WAN. One embodiment provides appropriate services 160 to users of local networks (e.g., home networks) by exploiting meaningful context information. In one embodiment, once services are discovered, users may select the desired services (e.g., from a list of available services).

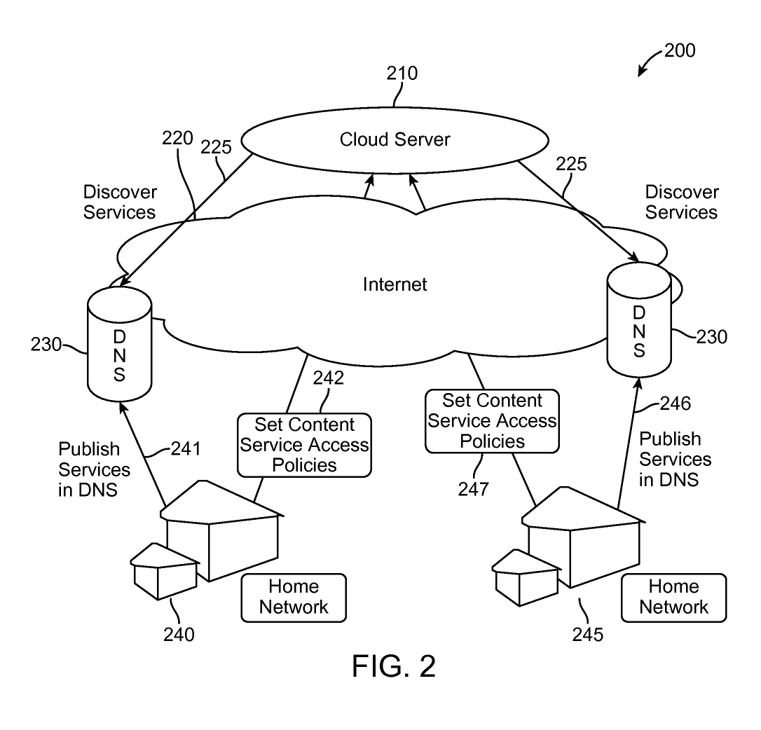

In one embodiment, the multi-tier discovery architecture 100 provides a mechanism for expanding UPnP service discovery beyond LANs to WANs (e.g., a cloud network environment) by using DNS. In one embodiment, DNS service records (SRV) include an added UPnP device description URL that provides a link to a UPnP device description document. In one embodiment, the multi-tier discovery architecture 100 uses a DNS update mechanism to publish UPnP service discovery information for connecting multiple homes and for accessing content through a server (e.g., server 210 in FIG. 2) in the WAN.

In one embodiment, the multi-tier discovery architecture 100 provides aggregate views of content for a group of homes or users. In one embodiment, the multi-tier discovery architecture 100 enables UPnP service discovery in the cloud network environment and enables multi-home connection for service and content access without requiring remote access servers in the homes. In one embodiment, the multi-tier discovery architecture 100 does not require new infrastructure and uses existing DNS infrastructure to extend UPnP service discovery to the WAN. In one embodiment, the multi-tier discovery architecture 100 does no requite a new protocol to publish and access service discovery through the DNS.

In one embodiment, by adding service discovery information to DNS records of a DNS, selected services may be advertised for connecting multiple home networks for content and service access. In one embodiment, a domain is used for service lookup, and a DNS query returns a list of instances of desired services. In one embodiment, DNS SRV records provide the following information: “_http._tcp.example.com.” lists all address/port combinations for http servers reachable by TCP in the example.com. domain. This assumes that the user desires any web server in “example.com,” which is not a likely scenario. In one embodiment, DNS-SD adds one level of indirection to allow a named list of services that may be presented to the user of a LAN (e.g., home network). In one embodiment, a query may be used by one embodiment for pointer records (PR) with an example name_ipp._tcp.example.com. Get a list of <instance>.<service>.<domain>. For example, “Color Printer-Sales._ipp._tcp.example.com,” “Slow Printer (Sally)._ipp._tcp.example.com.”

In one embodiment, the user is provided with a list of options that is selectable. In one embodiment, an SRV query is issued to obtain the actual IP and port number for the selected instance. A TXT query is issued for additional parameters (e.g., printer queue name). It is noted that UPnP Service Discovery Protocol (SSDP) does not work in the WAN. Therefore, in one embodiment, a new protocol may be provided as UPnP WAN Service Discovery Protocol (UWSDP) for providing UPnP discovery in the wide area. In one embodiment, a DNS SRV record for a service provides the port number and target host name where the service can be found. Additionally, in one embodiment, the DNS-SD TXT record may provide additional information about the service. In one embodiment, the DSD-SD TXT record provides UPnP service discovery (SD) information. In one embodiment, the DNS TXT record may be up to 65535 bytes long. It is noted that a DNS-SD TXT record is intended to be 200 bytes or less. DNS-SD TXT records can store arbitrary key/value pairs. In one embodiment, the DNS-SD TXT record stores a UPnP device description document (DDD) URL.

In one embodiment, the UPnP service availability may be updated in a DNS based on RFC 2136 (Dynamic Updates in the Domain Name System (DNS Update)). It is noted that a security issue may arise in that anyone who can reach an authoritative name server can alter the content of any zones on that server. In order to avoid this problem, in one embodiment, DNS update should only be used with RFC 2137 (Secure Domain name System Dynamic Update).

In one embodiment, it is envisioned that UWSDP standardization may occur. In an IETF standardization venue. In one embodiment, the UPnP WAN Service Discovery Protocol uses a DNS-SD TXT field to convey a DDD.

FIG. 2 shows a block diagram for an architecture 200 for service discovery and multi-home service/content access, according to an embodiment of the invention. In one embodiment, the architecture 200 includes a cloud server 210, WAN 220 (e.g., Internet), one or more DNS servers 230 and LANs 240 and 245 (e.g., home networks). In one embodiment, the architecture 200 expands UPnP service discovery using DNS server 230 so that services in the LANs 240 and 245 may be discovered outside of the LANs 240 and 245 in the cloud server 210.

In one embodiment, the DNS server 210 may reside in the cloud environment or anywhere in the WAN 220. In one embodiment, once a resolver makes a DNS request to a DNS server 230 which it cannot resolve, the DNS server 230 will respond with an alternate DNS address for the resolver to contact. In one embodiment DNS resource records are named and structured to facilitate service discovery. In one embodiment, the LAN 240 published services in the DNS 230 via communication 241, and the LAN 245 published services in the DNS 230 via communication 246. In one embodiment, a DNS query returns a list of instances of desired services from communications 220 for the LAN 240 and communications 225 for LAN 245.

In one embodiment, UPnP service availability may be updated in a DNS server 230 using RFC 2136 (Dynamic Updates in the Domain Name System). In one embodiment, a DNS SRV record for a service accessed from the cloud server 210 provides the port number and the target host name where the service can be found, and a TXT record provides additional information about the service.

In one embodiment, to discover a UPnP service through the DNS server 230, the service must publish UPnP service discovery information into the TXT field of a DNS record via communications 241 for LAN 240 and via communication 246 for LAN 245. In one embodiment, the TXT field may contain the UPnP DDD URL. In another embodiment, the DDD URL is included in the SRV.

In one embodiment, service lookup is handled as follows. DNS resource records are named and structured. Information that is required for service discovery is obtained: type of service and domain for service lookup. A DNS query returns a list of instances of desired services. DNS SRV records provide, e.g., an SRV record for “-http._tcp.example.com” list all address/port combinations for http servers reachable by transmission control protocol (TCP) in the example.com. This assumes that user wants any web server in the example.com domain. However, DNS service discovery adds one level of indirection to allow a named list of services that can be presented to the user. A query for PTR records is made. The user is provided with a list of options and user selects a service. An SRV query is issued to obtain the actual IP and port number for the selected instance. A TXT query is issued for additional parameters (UPnP Device Description URL). In one embodiment, the LANs 240 and 245 may set content/service access policies (e.g., restrictions) through communications 242 and 247, respectively.

In one embodiment, architecture 200 provides for content aggregation and content access through a family/group cloud accessed through the cloud server 210. In one embodiment, the content may be distributed among multiple homes (e.g., multiple LANSs) among the family/group members. In one embodiment, device applications at home (e.g., in a LAN 240 or 245) requires aggregated view of content. In one embodiment, the architecture 200 provides for family/group cloud interfaces with multiple homes (e.g., LANS 240, 245, etc.) and provides integrated view of content directory and means to access content.

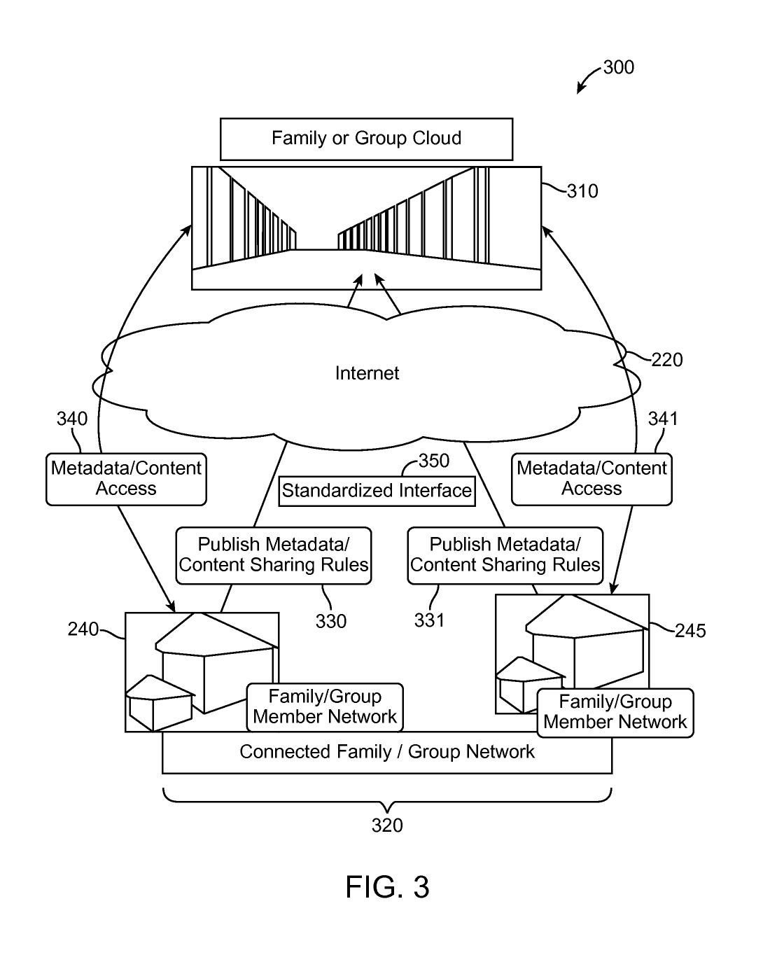

FIG. 3 shows an architecture 300 for multiple home/group member LANs 240 and 245 connected through a family or group cloud 310 environment, according to an embodiment of the invention. In one embodiment, architecture 300 includes a connected family/group network 320 including LAN 240 and LAN 245. In one embodiment, architecture 300 provides for multiple home/group member networks (e.g., LAN 240 and 245) to be connected through the cloud network environment through a family or group cloud 310. In one embodiment, a standard interface 350 may be used to access aggregated metadata through communications 340 and 341 about content through the family or group cloud 310. In one embodiment, the LAN 240 publishes metadata/content sharing rules 330 through the standard interface 350, and the LAN 245 publishes metadata/content sharing rules 331 through the standard interface 350.

In one embodiment, the standard interface 350 provides for defining sharing rules of metadata and content from each individual home network (e.g., LAN 240, 245) or group member network 320. In one embodiment, the standard interface 350 provides access of content and metadata through the family or group cloud 310 or directly through the home networks (e.g., LAN 240, 245) connected by the family cloud service. In one embodiment, the standard interface 350 provides for moving items from one home network (e.g., LAN 240) to another (e.g., LAN 245) through the connection established between the home networks by the family/group cloud service. In one embodiment, the standard interface 350 provides setup for identity and access rights through the family cloud service.

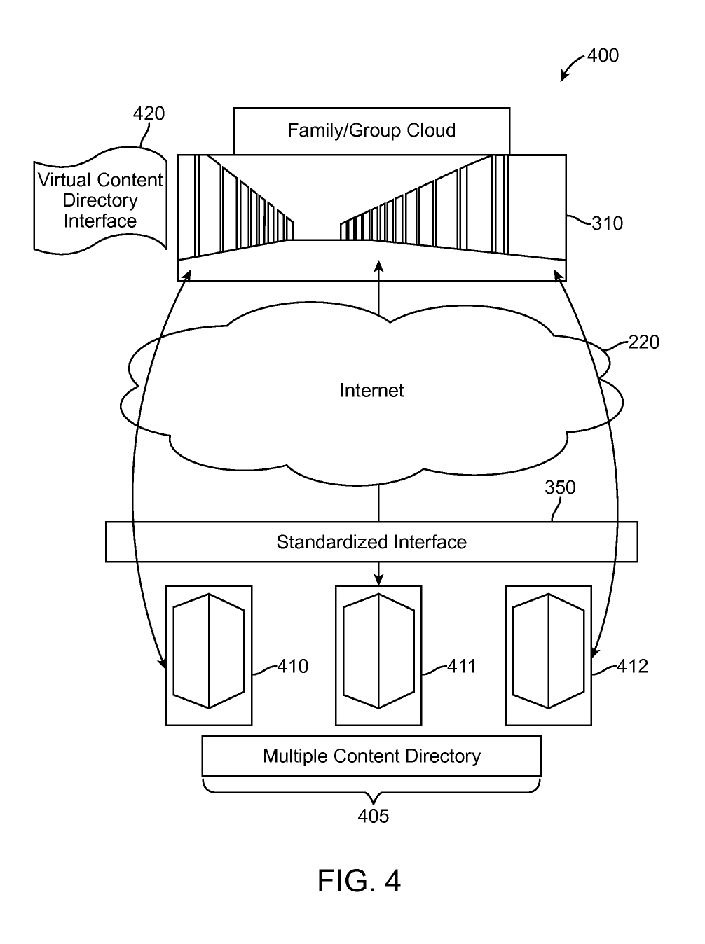

FIG. 4 shows an architecture 400 for a family/group cloud 310 network environment that serves as a virtual content directory service through an interface 420, and aggregates metadata from multiple content directory sources 410, 411 and 412 through the standard interface 350, according to an embodiment of the invention. In one embodiment, architecture 400 provides for virtualization of a multiple content directory 405 through the family/group cloud 310. In one embodiment, the family/group cloud 310 serves as a virtual content directory service, which aggregates metadata from multiple content directory sources 410, 411, 412, etc. In one implementation this facilitates for a device in a home network to search/browse the virtual content directory 405 at the family/group cloud 310 and be able to find content that is located in a different home network. In one embodiment, a user may use their application of choice to play media from the family/group cloud 310 once they have connected to the service. In one implementation, the family/group cloud 310 may cache some of the content and stream it to the user's application. In another implementation, the family/group cloud 310 may connect two homes (e.g., two LANs), where one acts as a content provider and the other as a content renderer, where content may be played directly from the content provider.

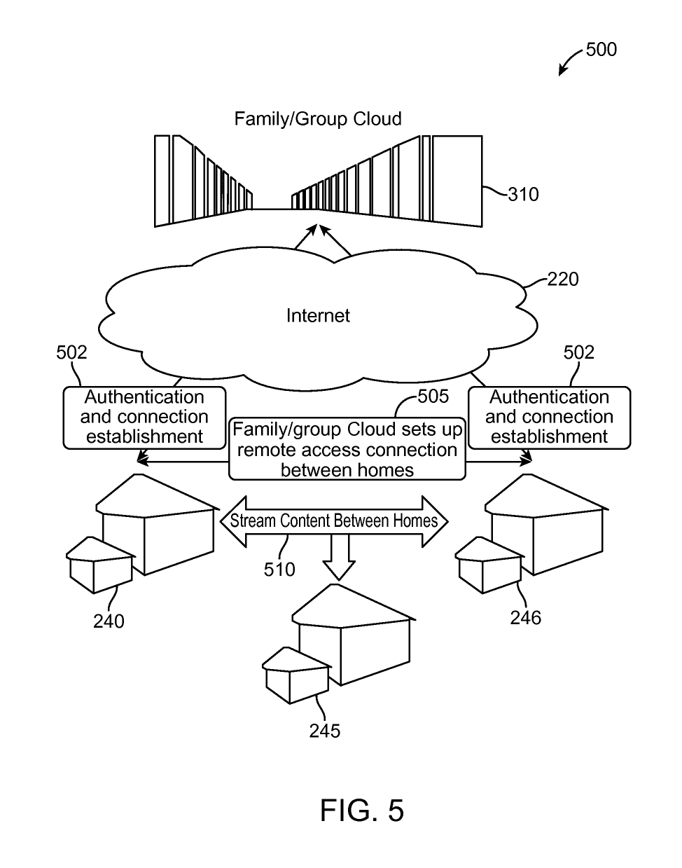

FIG. 5 shows an architecture 500 for the family/group cloud 310 network environment that serves as the authentication and connection establishment server to setup remote access connection between a home/group member network (e.g., LAN 240, LAN 245 and LAN 246), according to an embodiment of the invention. In one embodiment, the family/group cloud 310 serves as the authentication and connection establishment server through communications 502 to setup remote access connection 505 between a home/group member network. In one embodiment, each home/group member network authenticates itself with the family/group cloud 310 and the family/group cloud 310 sets up the remote access connection between the networks (e.g., LAN 240, 245 and 246). In one embodiment, the standardized interface 350 (FIG. 3) is be required to interface with the family/group cloud 310 and the home/group network. In one embodiment, connections to multiple home networks provides for streaming of content 510 between the home networks (e.g., LANs 240, 245 and 246).

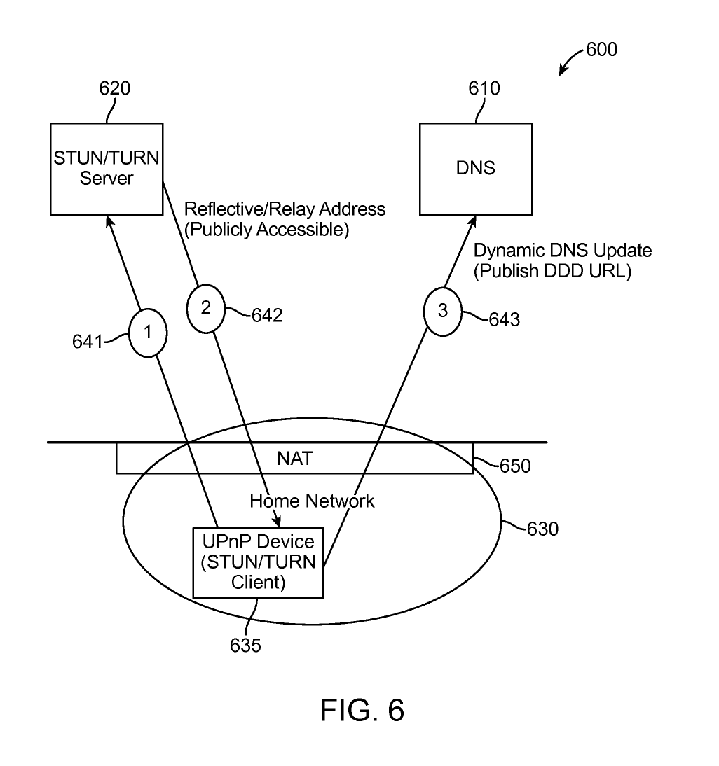

FIG. 6 shows an architecture 600 for publication of UPnP Service/device description in a DNS system 610 using of simple traversal of user datagram protocol (UDP) (STUN) through network address translation (NAT) (TURN) traversal using relay NAT, according to an embodiment of the invention. In one embodiment, the architecture includes STUN/TURN server 620, home network 630, NAT 650 and a home device (e.g., STUN/TURN client) 635. It is noted that in one embodiment, a UPnP service in a home network 630 most likely may be behind a NAT 650 with a private address and port. This service will be un-accessible from the WAN due to this public IP address that needs to be assigned to the service. In order to resolve this problem, in one embodiment, the service advertisement in the DNS 610 for UPnP service uses a publicly accessible IP address and port for the URL of the DDD URL. In one implementation, the use of STUN/TURN servers 620 enables to obtain a publicly accessible IP address for the UPnP device/service. In this implementation, an inbound request may access the UPNP DDD URL to be properly routed to the home network and accessible from outside of the home network (e.g., the home network 630).

In one embodiment, the process for obtaining a publicly accessible IP address for the DDD URL of the UPnP device 635 may be implanted using communications, in order, of 641, 642 and 643. The STUN/TURN server 620 returns a reflective/relay address (publicly accessible) to the UPnP device 635. The UPnP device 635 communicates a dynamic DNS update (publish DDD URL) to the DNS 610.

In one embodiment, a UPnP DDD update to the DNS 610 uses DDNS (RFC 2136), which has its own security mechanism to authenticate the updates with managed name servers. In one implementation, through a DNS query using DNS 610, it is possible to discover a default domain or list of domains for registering UPnP services using dynamic updates (dr._upnp._dns-sd._udp.<domain>; r._upnp._dns-sd._udp.<domain>). In one embodiment, the DNS query returns a list of servers or a default UPnP service registration server. In one implementation, the default UPnP server or a UPnP server from the list may be used with a dynamic DNS mechanism to publish a UPNP DDD URL (see above for the appropriate field to be used for a UPNP DDD URL). In one implementation, the UPnP device (STUN/TURN client) 635 first communicates with the STUN/TURN server 620.

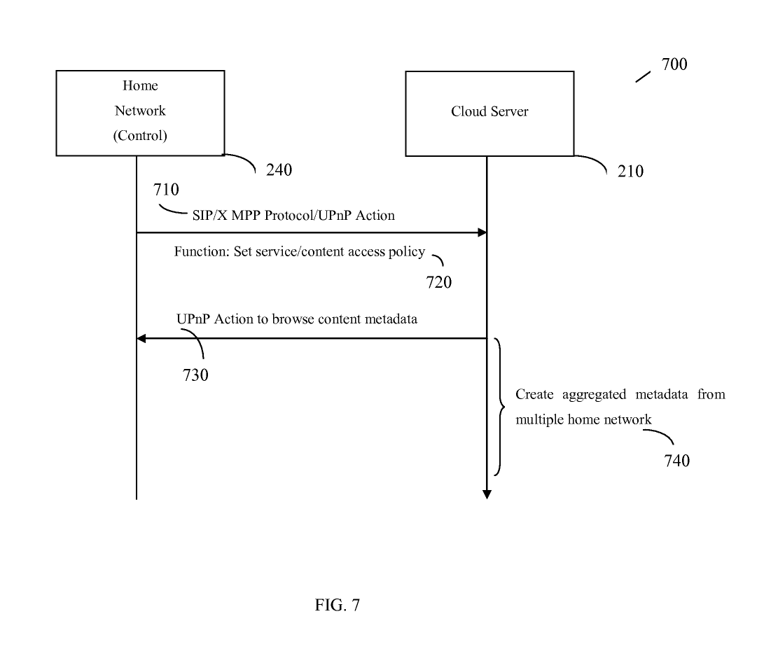

FIG. 7 shows an architecture 700 for a multi-home service/content access using service discovery in a cloud network environment using cloud server 210, according to an embodiment of the invention. In one embodiment, architecture 700 provides for multi-home service/content access to be achieved once service discovery in the cloud server 210 is enabled as described above. In one implementation, the sequence below describes how aggregate views of content may be achieved in the cloud server 210. A device in a LAN 240 (e.g., home network) may access the cloud server 210 and view the aggregated view of content stored in multiple home networks.

In one embodiment, the cloud server 210 accesses the metadata of content from each home and creates an aggregate content directory 740. The aggregate content directory 740 is exposed to the devices in multiple home networks. In one implementation, the protocol between the cloud server 210 and the device in the home network (LAN 240) may be UPnP action 730 or SIP/XMPP 710. The UPnP action 730 or the SIP/XMPP 710 protocol is used to interact between the cloud server 210 and the UPnP device in the home network (LAN 240) to set up policies 720 for content access rights.

In one embodiment, the control point (device responsible to set service/content access policy) in the home network (LAN 240) sets the service/content access policies by invoking UPnP action 730 or SIP/XMPP 710 messaging protocol on the cloud server 210. In the case of a UPnP action 730, the cloud server 210 updates the service in the DNS (e.g., DNS 230 for the devices in the home network (LAN 240) to discover. In one embodiment, the access policy rules may be described in extensible markup language (XML) format.

In one embodiment, the cloud server 210 browses content metadata from multiple sources in the home network (LAN 240) and creates an aggregated view of metadata stored in the cloud server 210 that may be accessible by multiple home networks based on access rules. In one implementation, the cloud server 210 may expose a virtual content directory service and devices from multiple home networks may access this service. In one embodiment, the cloud server 210 may serve the actual content from the cloud environment itself or may provide the URL of the content located in a home server for the device to access. In the later scenario, the access policy is applied while granting the access of the content.

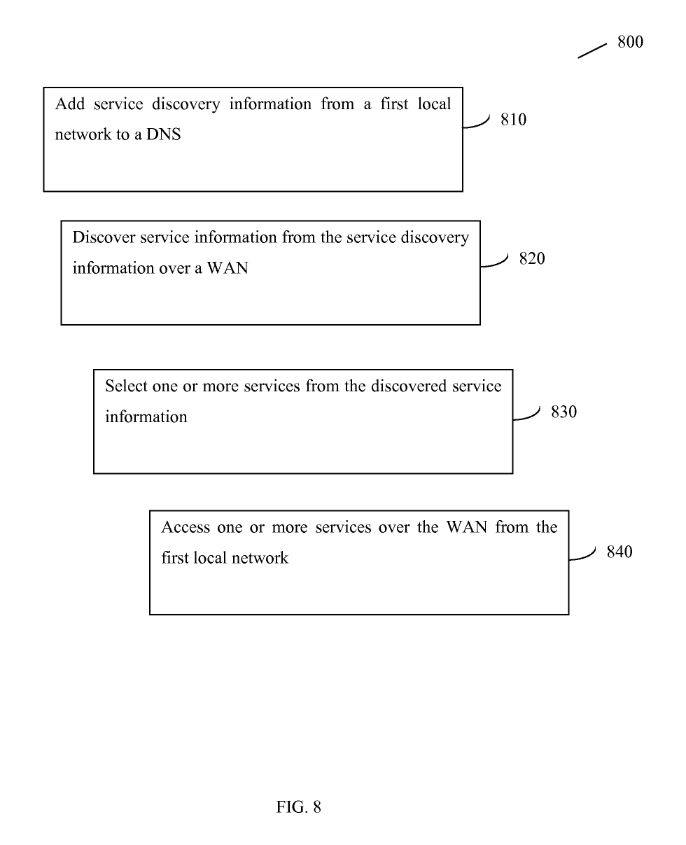

FIG. 8 shows a flowchart for service discovery in a WAN (e.g., a cloud network environment) for process 800, according to an embodiment of the invention. In one embodiment, service discovery information is added from a first local network (e.g., LAN 240 in FIG. 2) in process block 810, such as a UPnP DDD URL). Service information is discovered from the service discovery information (e.g., services in a UPnP DDD of a LAN/home network or family/group cloud) over a WAN in process block 820. One or more services (or content) are selected from the discovered service information in process block 830. One or more services are accessed over the WAN from the first local network in process block 840.

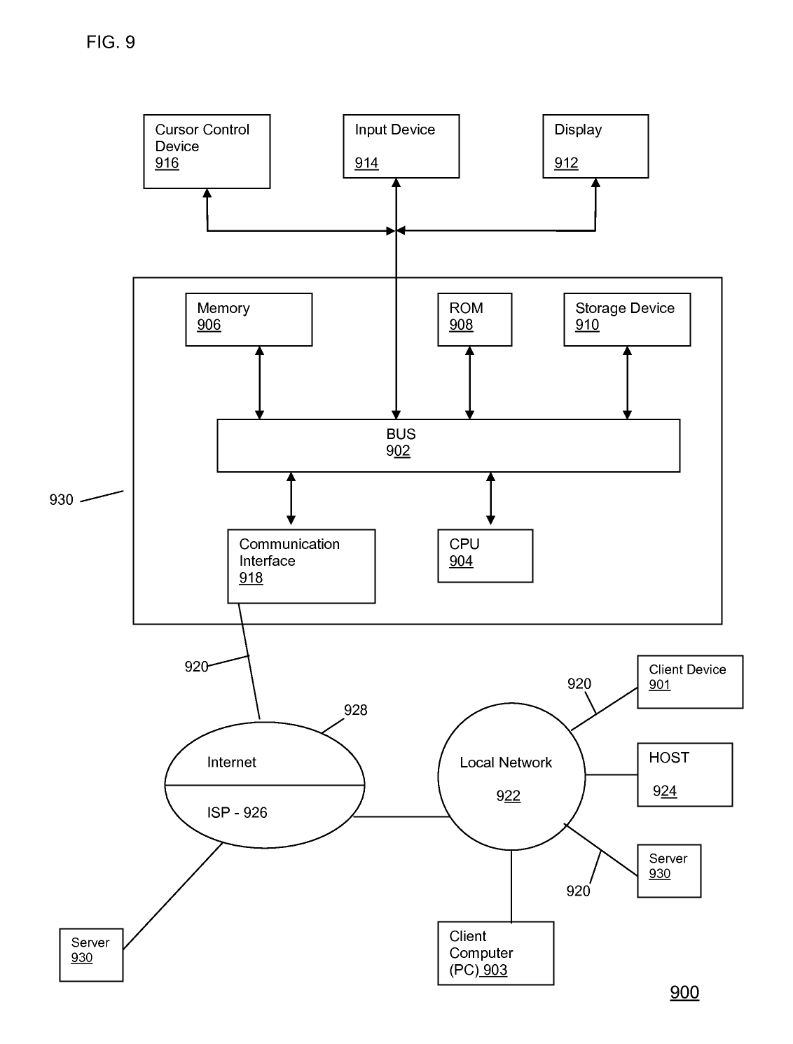

FIG. 9 shows a block diagram of an example system 900 in which an embodiment of the invention may be implemented. The system 900 includes one or more client devices 901 such as consumer electronics devices or a client computer 903 (e.g., personal computer (PC)), connected to one or more server computing systems 930. A server 930 includes a bus 902 or other communication mechanism for communicating information, and a processor (CPU) 904 coupled with the bus 902 for processing information. The server 930 also includes a main memory 906, such as a random access memory (RAM) or other dynamic storage device, coupled to the bus 902 for storing information and instructions to be executed by the processor 904. The main memory 906 also may be used for storing temporary variables or other intermediate information during execution or instructions to be executed by the processor 904. The server computer system 930 further includes a read only memory (ROM) 908 or other static storage device coupled to the bus 902 for storing static information and instructions for the processor 904. A storage device 910, such as a magnetic disk or optical disk, is provided and coupled to the bus 902 for storing information and instructions. The bus 902 may contain, for example, thirty-two address lines for addressing video memory or main memory 906. The bus 902 can also include, for example, a 32-bit data bus for transferring data between and among the components, such as the CPU 904, the main memory 906, video memory and the storage 910. Alternatively, multiplex data/address lines may be used instead of separate data and address lines.

In one embodiment, system 900 may enable cloud computing services for hosting data and compute services at a data site for remote clients. In one example, the system 900 is configured for hosting the running applications for extensible UPnP service discovery in a WAN using DNS and the storing associated data remotely for client device 901 over the network 922. Accordingly, system 900 may enable parallelism and scalability in a cloud to run data intensive applications with large data sets. For example, streaming content (e.g., video, audio, text, etc.) applications, service/content discovery applications, content and content directory sharing applications, etc.

The server 930 may be coupled via the bus 902 to a display 912 for displaying information to a computer user. An input device 914, including alphanumeric and other keys, is coupled to the bus 902 for communicating information and command selections to the processor 904. Another type or user input device comprises cursor control 916, such as a mouse, a trackball, or cursor direction keys for communicating direction information and command selections to the processor 904 and for controlling cursor movement on the display 912.

According to one embodiment of the invention, the functions of the invention are performed by the processor 904 executing one or more sequences of one or more instructions contained in the main memory 906. Such instructions may be read into the main memory 906 from another computer-readable medium, such as the storage device 910. Execution of the sequences of instructions contained in the main memory 906 causes the processor 904 to perform the process steps described herein. One or more processors in a multi-processing arrangement may also be employed to execute the sequences of instructions contained in the main memory 906. In alternative embodiments, hard-wired circuitry may be used in place of or in combination with software instructions to implement the invention. Thus, embodiments of the invention are not limited to any specific combination of hardware circuitry and software.

Various forms of computer readable media may be involved in carrying one or more sequences of one or more instructions to the processor 904 for execution. For example, the instructions may initially be carried on a magnetic disk of a remote computer. The remote computer can load the instructions into its dynamic memory and send the instructions over a telephone line using a modem. A modem local to the server 930 can receive the data on the telephone line and use an infrared transmitter to convert the data to an infrared signal. An infrared detector coupled to the bus 902 can receive the data carried in the infrared signal and place the data on the bus 902. The bus 902 carries the data to the main memory 906, from which the processor 904 retrieves and executes the instructions. The instructions received from the main memory 906 may optionally be stored on the storage device 910 either before or after execution by the processor 904.

The server 930 also includes a communication interface 918 coupled to the bus 902. The communication interface 918 provides a two-way data communication coupling to a network link 920 that is connected to the world wide packet data communication network now commonly referred to as the Internet 928. The Internet 928 uses electrical, electromagnetic or optical signals that carry digital data streams. The signals through the various networks and the signals on the network link 920 and through the communication interface 918, which carry the digital data to and from the server 930, are exemplary forms or carrier waves transporting the information.

In another embodiment of the server 930, interface 918 is connected to a network 922 via a communication link 920. For example, the communication interface 918 may be an integrated services digital network (ISDN) card or a modem to provide a data communication connection to a corresponding type of telephone line, which can comprise part of the network link 920. As another example, the communication interface 918 may be a local area network (LAN) card to provide a data communication connection to a compatible LAN. Wireless links may also be implemented. In any such implementation, the communication interface 918 sends and receives electrical electromagnetic or optical signals that carry digital data streams representing various types of information.

The network link 920 typically provides data communication through one or more networks to other data devices. For example, the network link 920 may provide a connection through the local network 922 to a host computer 924 or to data equipment operated by an Internet Service Provider (ISP) 926. The ISP 926 in turn provides data communication services through the Internet 928. The local network 922 and the Internet 928 both use electrical, electromagnetic or optical signals that carry digital data streams. The signals through the various networks and the signals on the network link 920 and through the communication interface 918, which carry the digital data to and from the server 930, are exemplary forms or carrier waves transporting the information.

The server 930 can send/receive messages and data, including e-mail, program code, through the network, the network link 920 and the communication interface 918. Further, the communication interface 918 can comprise a USB/Tuner and the network link 920 may be an antenna or cable for connecting the server 930 to a cable provider, satellite provider or other terrestrial transmission system for receiving messages, data and program code from another source.

The example versions of the invention described herein may be implemented as logical operations in a distributed processing system such as the system 900 including the servers 930. The logical operations of the present invention may be implemented as a sequence of steps or processes.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of the invention.

Though the present invention has been described with reference to certain versions thereof; however, other versions are possible. Therefore, the spirit and scope of the appended claims should not be limited to the description of the preferred versions contained herein.

What is claimed is:

1. A method for service discovery in a communication network, comprising:
adding service discovery information for a first network to a domain name system (DNS), wherein the service discovery information provides for devices to discover services that other devices support;
discovering service information from the service discovery information over the communication network;
selecting one or more services from the first network from the discovered service information; and
accessing one or more services over the communication network from the first network.

2. The method of claim 1, wherein the service discovery information comprises a link to a device description document.

3. The method of claim 2, wherein the link comprises a uniform resource locator (URL) to a universal plug and play (UPnP) device description document.

4. The method of claim 3, wherein discovering the service information comprises UPnP service discovery occurring in the communication network.

5. The method of claim 4, further comprising discovering content from the first network in the communication network.

6. The method of claim 5, wherein the first network comprises a first local network, and wherein a second local network accesses the one or more services and content over the communication network from the first local network, wherein the communication network is a wide area network (WAN).

7. The method of claim 6, wherein the second local network accesses the one or more services and content from the first local network.

8. The method of claim 7, wherein the WAN comprises a cloud network environment.

9. The method of claim 8, wherein content from multiple home networks are aggregated and accessible over the cloud network environment, and an aggregated content directory is provided to the multiple home networks.

10. The method of claim 1, wherein the service discovery information from the first local network is added to a service record (SRV) of the DNS.

11. The method of claim 10, further comprising adding service discovery information in a text (TXT) field of a DNS record.

12. The method of claim 10, wherein the additional service information comprises a uniform resource locator (URL) to a universal plug and play (UPnP) device description document.

13. The method of claim 12, wherein UPnP service availability is updated in a DNS SRV.

14. The method of claim 11, wherein a UPnP WAN service discovery protocol uses another field for device description information.

15. The method of claim 1, wherein the first network is a first home network, and the communication network is a wide area network (WAN), wherein a second home network discovers the service information from the service discovery information of the first home network over the WAN, and the second home network selects the one or more services from the first home network from the discovered service information.

16. The method of claim 15, wherein the second home network discovers devices in the first home network and services that the discovered devices support.

17. A computer program product for service discovery in a communication network, the computer program product comprising:
a tangible storage medium readable by a computer system and storing instructions for execution by the computer system for performing a method comprising:
adding service discovery information for a first network to a domain name system (DNS), wherein the service discovery information provides for devices to discover services that other devices support;
discovering service information from the service discovery information over the communication network;
selecting one or more services from the first network from the discovered service information; and
accessing one or more services over the communication network from the first network.

18. The computer program product of claim 17, wherein the service discovery information comprises a link to a device description document.

19. The computer program product of claim 18, wherein the link comprises a uniform resource locator (URL) to a universal plug and play (UPnP) device description document.

20. The computer program product of claim 19, wherein discovering the service information comprises UPnP service discovery occurring in the communication network, wherein the communication network comprises a wide area network (WAN).

21. The computer program product of claim 20, further comprising:
discovering content from the first network in the WAN, wherein the first network comprises a first local network, and
wherein a second local network accesses the one or more services and content over the WAN from the first local network.

22. The computer program product of claim 21,
wherein the second local network accesses the one or more services and content from the first local network, and
wherein the WAN comprises a cloud network environment.

23. The computer program product of claim 22, wherein content from multiple home networks are aggregated and accessible over the cloud network environment, and an aggregated content directory is provided to the multiple home networks.

24. The computer program product of claim 17, wherein the service discovery information from the first local network is added to a service record (SRV) of the DNS.

25. The computer program product of claim 24, further comprising adding service discovery information in a text (TXT) field of a DNS record.

26. The computer program product of claim 24, wherein UPnP service availability is updated in a DNS SRV.

27. The computer program product of claim 25, wherein a UPnP WAN service discovery protocol uses another field for device description information.

28. The computer program product of claim 17, wherein the first network is a first home network, and the communication network is a wide area network (WAN), wherein a second home network discovers the service information from the service discovery information of the first home network over the WAN, and the second home network selects the one or more services from the first home network from the discovered service information.

29. A system comprising:
a server coupled to a wide area network (WAN);
a first local network coupled to the WAN, and
a domain name system (DNS) coupled to the server, the DNS including service discovery information for the first local network;
wherein service information from the local network is discoverable over the WAN using the service discovery information from the DNS.

30. The system of claim 29, wherein the service discovery information comprises a link to a device description document for the first local network.

31. The system of claim 29, wherein the link comprises a uniform resource locator (URL) to a universal plug and play (UPnP) device description document for the first local network.

32. The system of claim 31, wherein the service information is discoverable based on UPnP service discovery occurring in the WAN using the DNS.

33. The system of claim 32, further comprising a second local network coupled to the WAN, wherein the second local network accesses the one or more services and content from the first local network over the WAN, wherein the WAN comprises a cloud network environment.

34. The system of claim 33, wherein content from multiple home networks are aggregated and accessible over the cloud network environment, and an aggregated content directory is provided to the multiple home networks.

35. The system of claim 34, wherein the service discovery information from the first local network is added to a DNS service record (SRV).

36. The system of claim 35, wherein additional service discovery information is added in a text (TXT) field of a DNS record for providing service and content discovery over the cloud network environment.

37. The system of claim 35, wherein UPnP service availability is updated in a DNS SRV.

38. The system of claim 35, wherein the DNS uses a UPnP WAN service discovery protocol for service and content discovery over the cloud network environment, wherein a DNS-SD TXT field includes device description information.

39. The system of claim 38, wherein the DNS uses a UPnP WAN service discovery protocol for service and content discovery over the cloud network environment, wherein another field includes device description information.

40. The system of claim 29, wherein the service discovery information for the first local network is published dynamically using a DNS query.

41. The system of claim 40, wherein the DNS performs the DNS query for returning a list of servers, wherein a UPnP server from the list of servers is used for publishing a UPnP device description document URL.

42. A system comprising:
a server coupled to a wide area network (WAN);
a first local network coupled to the WAN, and
a domain name system (DNS) coupled to the WAN, wherein the DNS obtaining service discovery information using a publicly accessible Internet protocol (IP) address and port for a link to the service discovery information;
wherein service information from the local network is discoverable over the WAN.

43. The system of claim 42, wherein the server uses a simple traversal user datagram protocol (STUN) through network address translation (TURN) traversal using a relay network address translation (NAT) with a device in the first local network to publish service description in the DNS.

44. The system of claim 43, wherein the first network is a first home network, wherein a second home network discovers the service description of the first home network over the WAN, and the second home network selects one or more services from the first home network from the discovered service description.

45. The system of claim 44, wherein the server returns a reflective address that is publicly accessible to a device in the first home network, and the device communicates a DNS update to publish a device description document universal resource locator (URL) to the DNS.

46. The system of claim 45, wherein the device is a universal plug and play (UPnP) device).
